(19) United States
(12) Patent Application Publication
(10) Pub. No.: US 2010/0068337 A1
(43) Pub. Date: Mar. 18, 2010

(54) PACKAGED ANIMAL FOODS INCLUDING BENEFICIAL VIRUSES, METHODS FOR PACKAGING AND STORING ANIMAL FOODS, AND METHODS FOR FEEDING ANIMALS

(76) Inventors: Justin C. Reber, Highland, UT (US); Alan K. Walbeck, Sandy, UT (US)

Correspondence Address: TRASKBRITT, P.C., P.O. BOX 2550, SALT LAKE CITY, UT, 84110, US

(21) Appl. No.: 12/511,894

(22) Filed: Jul. 29, 2009

Related U.S. Application Data
(63) Continuation-in-part of application No. 12/212,554, filed on Sep. 17, 2008.

(51) Int. Cl. A23K 1/18; A23K 1/16

(52) U.S. Cl. 426/2; 426/61

(57) ABSTRACT

An animal food includes at least one type of beneficial virus (e.g., a bacteriophage, etc.) that controls or prevents proliferation of one or more undesirable microorganisms. An animal food of the present invention is formulated with the health of the animal for it is formulated in mind. In addition, the animal food may be formulated to eliminate or control populations of one or more undesirable microorganisms as the animal food is stored or exposed to ambient conditions. Methods for manufacturing an animal food include mixing an animal food with a composition that includes at least one beneficial virus. Such a method may optionally include packaging the animal food. Methods for storing animal foods and for feeding animals are also disclosed.

### CROSS-REFERENCE TO RELATED APPLICATION

This application is a continuation-in-part of U.S. patent application Ser. No. 12/212,554, filed on Sep. 17, 2008, pending.

### TECHNICAL FIELD

The present invention relates generally to animal foods and, more specifically, to animal foods that include at least one type of beneficial virus (e.g., a bacteriophage, etc.) that controls or prevents proliferation of one or more undesirable microorganisms). In particular, the present invention relates to animal foods that have been formulated with the health of the animal for which they are formulated in mind. Even more particularly, the present invention relates to packaged animal foods, as well as to methods for packaging animal foods and to methods for feeding animals.

### BACKGROUND OF RELATED ART

The application of bacteriophage to foods is known in the art. Bacteriophage has been applied to animal carcasses and to cut produce. Bacteriophage has been used on foods to prevent the proliferation of bacteria that are pathogenic, even potentially deadly, to those who will subsequently consume, or eat, the food. Typically, extremely high dosages of bacteriophage are applied to the food to eradicate pathogenic bacteria from the food, which prevents the spread of and infections by the pathogenic bacteria. It appears that the sole purpose for using bacteriophage with foods is to prevent the transfer of undesirable microorganisms to humans.

Once bacteriophage has been applied to meats or cut produce, the meats or cut produce are typically refrigerated or frozen to prevent spoilage. The bacteriophage that inevitably remains on meats and cut produce is removed as the food is washed or destroyed as the food is cooked. Thus, little or none of the bacteriophage is consumed with the food.

### SUMMARY

The present invention includes animal foods, as well as a composition that includes one or more types of beneficial viruses (e.g., bacteriophage, or, more simply, “phage,” etc.) that control or prevent the proliferation of one or more undesirable microorganisms (e.g., pathogens, microorganisms that cause food to spoil, etc.). The virus-containing composition may be formulated to diminish, control, or maintain a load or population of one or more types of undesirable microorganisms (e.g., bacteria, etc.) in the animal food to an acceptable level (e.g., below a particular infectious dose (ID) for a predetermined percentage of an animal population, or at level that will have a certain likelihood (corresponding to the predetermined percentage) of preventing the bacteria from making the animal sick; at a level considered safe by a regulatory agency, such as the Food & Drug Administration (FDA) of the United States; etc.). One or more types of beneficial virus in the composition may be specific for at least one type of microorganism that may provide undesirable results (e.g., sickness, etc.) if eaten, or consumed, but an animal for which the animal food is formulated. The beneficial virus may target one or more undesirable microorganisms, including, but not limited to, pathogenic microorganism, which may causes disease states in animals that consume the animal food, microorganisms that may spoil the animal food, and microorganisms that may otherwise undesirably affect the animal food or an animal that consumes the animal food. In some embodiments, the composition lacks viruses that are able to infect the normal flora of an animal for which the animal food is formulated.

An animal food of the present invention may be packaged. When included with a packaged animal food, the virus-containing composition may be formulated to control or prevent proliferation of one or more undesirable microorganisms as the packaged animal food is stored or as it is exposed to ambient conditions for prolonged periods of time, such as when it is left out for the animal to eat. Such ambient conditions include, without limitation, an ambient temperature (i.e., room temperature) or an above-ambient temperature, ambient humidity, sunlight, and/or other conditions that may foster proliferation of the at least one undesirable microorganism.

In a method for manufacturing an animal food in accordance with teachings of the present invention, a composition that includes one or more types of beneficial virus is added to an animal food. The composition may be added to the animal food as the animal food is processed, the composition may be applied to surfaces of bits or pieces of the animal food, or the animal food and the composition may be mixed before or as they are introduced into a package.

In another aspect, the present invention includes methods for packaging, transporting, and storing animal foods, as well as methods for feeding an animal, such as a pet, or companion animal, livestock, or any other type of animal.

In order to feed an animal in accordance with teachings of the present invention, a packaged animal food is obtained. The packaged animal food may be formulated for the animal to which it is to be fed. The packaged animal food may be stored after it has been obtained, and even after the package within which the food is contained has been opened. After the packaged animal food has been opened, it may be set out for the animal to consume. During storage or as it sits, the animal food may be exposed to ambient conditions, including, but not limited to, an ambient or above-ambient temperature, ambient humidity, sunlight, and the like, for extended periods of time. The presence of at least one type of beneficial virus in the packaged animal food controls populations of undesirable microorganisms within the animal food, making it safe for consumption by the animal. In addition, in some embodiments, the at least type of beneficial virus may infect at least one type of undesirable microorganism, such as a type of microorganism that may cause the animal food to spoil, a type of microorganism that is pathogenic to the animal, or any other type of microorganism that may adversely affect the animal. In some further embodiments, the animal food may lack viruses that infect normal flora of the animal for which the food is formulated or intended.

Other aspects of the present invention, as well as features and advantages of various aspects of the present invention, will become apparent to those of ordinary skill in the art through consideration of the ensuing description and the appended claims.

### DETAILED DESCRIPTION

In one aspect, the present invention includes foods that are to be fed to animals, including pets, or “companion animals,” livestock, and other animals. In various embodiments, an animal food that incorporates teachings of the present invention includes an animal food and a composition that comprises one or more types of beneficial virus (e.g., bacteriophage, or, more simply, “phage,” etc.).

An animal food of the present invention may benefit an animal for which the food is formulated or intended. Unlike previous applications of bacteriophage to food, which ultimately ensure the health of humans, animal foods that incorporate teachings of the present invention are formulated to maintain or improve the health of the animal to which they are fed.

The animal food may be any suitable food or food product (e.g., processed food, etc.) in any suitable form. Without limiting the scope of the present invention, the animal food may comprise a dry animal food (e.g., kibble or another substantially dry (e.g., solid, dry to the touch, etc.) food product) or a wet animal food (e.g., solid chunks of meat, processed food including liquid, liquid food, etc.).

The beneficial virus of a composition may include or even consist of one or more be beneficial viruses that are intended to maintain or preserve the health of an animal for which the animal food is intended.

A composition that incorporates teachings of the present invention may include or even consist of one or more beneficial viruses that prevent one or more undesirable microorganisms (e.g., bacteria, etc.) from infecting an animal for which the food is formulated or intended. More specifically, the beneficial virus or viruses may target, or have specificity for, one or more undesirable microorganisms that are pathogenic to or otherwise adversely affect an animal (e.g., by causing the food to spoil, ferment, etc.) for which the food is formulated or intended. Upon infecting the targeted undesirable microorganism, the beneficial virus or viruses may lyse (i.e., kill) corresponding undesirable microorganisms and/or otherwise prevent proliferation of the corresponding undesirable microorganisms (e.g., by inserting genetic material at a location of an undesirable microorganism's genome responsible for replication, etc.).

The composition may lack viruses that are capable of infecting the normal flora of the animal for which the food is formulated or intended. In some embodiments, the composition may completely lack viruses that are capable of infecting any normal flora of microorganisms in or on the body of the animal for which the food is formulated or intended. In other embodiments, the composition may lack viruses that are capable of infecting a specific part of an animal's normal flora (e.g., the gut flora, etc.). Still other embodiments of an animal food of the present invention lack viruses that may infect one or more specific microorganisms (e.g., predominant microorganisms, such as various species of bacterial genera, including, but not limited to, Bacteroides, Clostridium, Fusobacterium, Eubacterium, Ruminococcus, Peptococcus, Peptostreptooccus, Bifidobacerium, and Lactobacillus and various species of fungal general, including, but not limited to, Candida, Saccharomyces, Aspergillus, and Malassezia; etc.).

The amount of each beneficial virus that is added to an animal food in accordance with teachings of the present invention may vary, depending upon the desired effect of each beneficial virus. In embodiments where a beneficial virus is included to substantially eliminate an undesirable microorganism or to reduce or maintain a population of an undesirable microorganism to an acceptable level (e.g., below a particular infectious dose for a predetermined percentage of an animal population, to a population or concentration considered by a regulatory agency, such as the U.S. FDA to be safe for that undesirable microorganism, etc.), the desired result may be obtained by adding a predetermined amount of the beneficial virus to the animal food. That amount may be determined by considering a variety of factors, such as the actual or predicted population or concentration of a corresponding undesirable microorganism in the animal food, the multiplicity of infection (MOI) of the beneficial virus for its corresponding undesirable microorganism, the target population or concentration of the undesirable microorganism, conditions (e.g., temperature, humidity, components of the animal food, etc.) to which the beneficial virus and the undesirable microorganism will be exposed, and/or the amount (e.g., weight, volume, etc.) of the animal food. Various formulas for determining the appropriate amount of beneficial virus to be added to an animal food to achieve a particular result (e.g., elimination, population control, etc., of one or more types of undesirable microorganisms) are well within the abilities of one of ordinary skill in the art.

In another aspect, the present invention includes methods for manufacturing animal foods. In such a method, a composition that includes at least one type of beneficial virus may be added to the animal food in any suitable manner known in the art. As a non-limiting example, the composition and the virus or viruses thereof may be incorporated into the interior of a wet or dry animal food in the manner described by U.S. patent application Ser. No. 12/212,554, filed on Sep. 17, 2008, and titled “METHODS FOR INTRODUCING BACTERIOPHAGE INTO THE INTERIORS OF QUANTITIES OF EDIBLE AGRICULTURAL PRODUCTS AND EDIBLE AGRICULTURAL PRODUCTS WITH PHAGE-CONTAINING PREPARATIONS IN THE INTERIORS THEREOF,” the entire disclosure of which is, by this reference, hereby incorporated herein. As another example, the composition may be applied to the animal food by more conventional techniques, such as application of a spray or powder to the surfaces of the animal food. Another technique for mixing the animal food and the composition includes introducing the animal food and the composition into the same package, or container.

In some embodiments, the animal food and the beneficial virus-containing composition may be packaged for transport, sale, and/or storage. In such embodiments, the package, or container, within which the animal food and beneficial virus-containing composition are packaged are suitable for the type of animal food being packaged. For example, kibble and other forms of dry animal food may be packaged in bags, plastic containers, or the like. Various forms of wet animal food may be sealed in cans or packaged in any other suitable manner known in the art.

The packaged animal food may then be stored under ambient conditions (e.g., at an ambient temperature (room) or an above-ambient temperature (an outdoor temperature that exceeds room temperature), under ambient humidity, etc.) for prolonged periods of time. When stored under ambient conditions, virus in the packaged animal food prevents proliferation of at least one type of undesirable microorganism, maintaining a population, or load, of at least one type of undesirable microorganism within an acceptable limit (e.g., at a population or concentration that is acceptable under U.S. FDA standards, below an infectious dose for a particular undesirable microorganism to a certain percentage of a population (of animals for which a particular animal food is formulated or intended), etc.).

Once the package is opened and the animal food is provided to an animal, the virus may continue to prevent proliferation of at least one type of undesirable microorganism or maintain a population or load of the at least one type of undesirable microorganism within an acceptable limit. Such control over proliferation of at least one undesirable microorganism may continue under circumstances where the animal food is exposed to a variety of conditions (e.g., ambient or above-ambient temperatures, ambient humidity, sunlight, etc.) for prolonged periods of time (e.g., minutes, hours, days, etc.) until the animal food is consumed by an animal.

Although the foregoing description contains many specifics, these should not be construed as limiting the scope of the present invention, but merely as providing illustrations of some exemplary embodiments. Similarly, other embodiments of the invention may be devised which do not depart from the spirit or scope of the present invention. Features from different embodiments may be employed in combination. The scope of the invention is, therefore, indicated and limited only by the appended claims and their legal equivalents, rather than by the foregoing description. All additions, deletions, and modifications to the invention, as disclosed herein, which fall within the meaning and scope of the claims are to be embraced thereby.

What is claimed:

1. A method for manufacturing an animal food, comprising:
adding a composition comprising phage to an animal food; and
packaging the animal food with the phage.

2. The method of claim 1, wherein adding the composition comprising phage to the animal food comprises adding a composition comprising phage to a pet food.

3. The method of claim 1, wherein adding a composition comprising phage to the animal food comprises adding phage selected to preserve the health of an animal for which the animal food is formulated.

4. The method of claim 3, wherein adding the composition comprising phage to the animal food comprises adding a composition consisting of phage that will infect a bacteria that may cause a disease state in the animal for which the food is formulated.

5. The method of claim 4, wherein adding the composition comprising phage to the animal food comprises adding a composition lacking phage that will infect normal flora of the animal for which the food is formulated.

6. The method of claim 1, wherein adding the composition comprising phage to the animal food comprises adding the composition to the animal food while processing the animal food.

7. The method of claim 1, wherein adding the composition comprising phage to the animal food comprises adding the composition to the animal food after preparing the animal food.

8. The method of claim 1, further comprising:
storing the packaged food with the phage at or above an ambient temperature.

9. The method of claim 8, wherein the adding the composition comprises adding a composition configured to maintain a bacterial load in the animal food at an acceptable level without providing an unacceptable level of phage in the animal food when the animal food is stored at or above the ambient temperature.

10. A packaged animal food, comprising:
a packaging container;
animal food in the packaging container; and
a composition including at least one type of phage in the packaging container.

11. The packaged animal food of claim 10, wherein the composition including at least one type of phage is distributed throughout the animal food.

12. The packaged animal food of claim 10, wherein the composition including at least one type of phage is on a surface of pieces of the animal food.

13. The packaged animal food of claim 10, wherein the animal food comprises a pet food.

14. The packaged animal food of claim 10, wherein the at least one type of phage of the composition includes phage selected to preserve the health of an animal for which the animal food is formulated.

15. The packaged animal food of claim 14, wherein the at least one type of phage of the composition comprises at least one type of phage that will infect a bacterial that may cause a disease state in the animal for which the food is formulated.

16. The packaged animal food of claim 14, wherein the composition lacking phage that will infect normal flora of the animal for which the food is formulated.

17. The packaged animal food of claim 10, wherein the at least one type of phage of the composition consists of phage selected to preserve the health of an animal for which the animal food is formulated.

18. The packaged animal food of claim 10, wherein the composition is formulated to enable storage of the animal food at or above an ambient temperature.

19. The packaged animal food of claim 18, wherein the composition is formulated to maintain a bacterial load in the animal food at an acceptable level without providing an unacceptable level of phage when the animal food is stored at or above the ambient temperature.

20. A method for feeding an animal, comprising:
obtaining a packaged animal food including an animal food with a bacterial load controlled by at least one type of phage;
opening the packaged animal food; and
providing the animal food to an animal.

21. The method of claim 20, further comprising:
storing the packaged animal food at or above an ambient temperature.

22. The method of claim 20, wherein providing the animal food to the animal comprises providing the animal food along with the at least one type of phage.

23. The method of claim 20, wherein providing the animal food to the animal comprises providing the animal food to a pet.
